(19) United States
(12) Patent Application Publication
(10) Pub. No.: US 2013/0067577 A1
(43) Pub. Date: Mar. 14, 2013

(54) Malware scanning

(71) Applicants: Pavel Turbin, Jokela (FI); Jani Jäppinen, Helsinki (FI)

(72) Inventors: Pavel Turbin, Jokela (FI); Jani Jäppinen, Helsinki (FI)

(73) Assignee: F-Secure Corporation

(21) Appl. No.: 13/199,964

(22) Filed: Sep. 14, 2011

(51) Int. Cl. G06F 21/00; G06F 11/00

(52) U.S. Cl. 726/24

(57) ABSTRACT

According to a first aspect of the present invention there is provided a method of scanning a computer device in order to detect potential malware when an operating system running on the computer device prevents applications installed on the device from accessing installed files of other applications installed on the device. The method includes the steps of detecting installation of an application on the device, identifying one or more installation files that are required to perform the installation of the application, and performing a malware scan of the identified installation files and/or information obtained from the installation files.

### TECHNICAL FIELD

The present invention relates to methods and apparatus for performing malware scanning for detecting malware, or other potentially unwanted programs. More particularly, the invention relates to methods and apparatus for performing malware scanning of a computer device when an operating system running on the computer device prevents applications installed on the device from accessing/reading the files of other applications installed on the device.

### BACKGROUND

Malware is short for malicious software and is used as a term to refer to any software designed to infiltrate or damage a computer device (e.g. a desktop personal computer (PC), laptop, tablet, personal data assistant (PDA), mobile phone, smart phone, or any other such device) without the owner's informed consent. Malware can include viruses, worms, trojan horses, rootkits, adware, spyware and any other malicious and unwanted software.

When a device is infected by a malware program the user will often notice unwanted behaviour and degradation of system performance as the infection can create unwanted processor activity, memory usage, and network traffic. This can also cause stability issues leading to application or system-wide crashes. The user of an infected device may incorrectly assume that poor performance is a result of software flaws or hardware problems, taking inappropriate remedial action, when the actual cause is a malware infection of which they are unaware. Furthermore, even if a malware infection does not cause a perceptible change in the performance of a device, it may be performing other malicious functions such as monitoring and stealing potentially valuable commercial, personal and/or financial information, or hijacking a device so that it may be exploited for some illegitimate purpose.

Many end users make use of anti-virus software to detect and possibly remove malware. In order to detect a malware file, the anti-virus software must have some way of identifying it amongst all the other files present on a device. Typically, this requires that the anti-virus software has access to a database containing the “signatures” or “fingerprints” that are characteristic of individual malware program files. When the supplier of the anti-virus software identifies a new malware threat, the threat is analysed and its signature is generated. The malware is then “known” and its signature can be distributed to end users as updates to their local anti-virus software databases. In addition to scanning for malware signatures, most anti-virus applications also employ some form of heuristic analysis. This approach involves the application of general rules intended to identify patterns that distinguish the behaviour of any malware from that of clean/legitimate programs. For example, the behaviour of all programs on a device are monitored and if a program attempts to write data to an executable program, the anti-virus software can flag this as suspicious behaviour. Heuristics can be based on behaviours such as API calls, attempts to send data over the Internet, etc, and can be particularly useful for detecting malware for which no signature has yet been generated.

Anti-virus applications typically provide on-demand scanning in which the user of a device determines when the files on a device should be scanned for the presence of malware. In on-demand scanning the user can activate the scanning process manually, or can configure the scanning process to start in certain circumstances. For example, the user could configure the anti-virus program to scan particular folders on a weekly basis, and to scan all the files on a device once a month. In addition, these anti-virus programs usually also provide real-time protection against malware by performing on-access scanning. In on-access scanning, a computer device is monitored for the presence of malware by scanning files automatically in the background as and when the files are accessed.

Due largely to technological improvements, the variety of computer devices available to users continues to grow. As a consequence, the variety of operating systems used by these devices also continues to grow. In particular, new types of computer devices providing functionality that has not previously been available require operating systems that have been specifically designed to support this new functionality. For example, devices such as tablet PCs and smart phones that provide touchscreens as a user input device, either as a replacement of or in addition to conventional user input devices such as a keyboard, keypad, mouse, trackpad etc, require operating systems designed to work with this hardware functionality. In addition, many of the operating systems that have been designed for devices such as tablet PCs and smart phones have also been designed to allow device users to quickly and easily expand the functionality of the device by downloading applications referred to as “apps”. In this regard, the term “app” is typically used to refer to small software applications that provide a specific/narrow function. For example, a large number of websites now have an app that is specifically associated with the website, which a device user can download in order to obtain regular updates from or direct access to the website content.

The functionality of some of these relatively new operating systems can prevent conventional anti-virus applications, which are intended to work with operating systems that have been largely designed for use with conventional desktop or laptop PCs (e.g. such as Linux®, Mac OS, and Microsoft® Windows®), from successfully performing malware scans. In particular, those operating systems that allow a device to rapidly access functionality by downloading and installing so-called apps are often designed with a strict security architecture that prevents software applications from reading and/or writing the files of another application in an attempt to prevent these apps from performing any operations that would adversely impact other applications, the operating system, or the user. However, as a consequence, an anti-virus application will also be prevented from reading the files of another application and will therefore be unable to scan these files to determine whether or not they relate to malware.

By way of example, the most common malware infection of devices that run Google's Android™ operating system typically occurs by way of a trojan/trojanised app that is installed on the device. It is therefore highly desirable to be able to determine if an application is infected with malware. However, once installed on a device running the Android operating system, each application is restricted to its own sandbox (i.e. is run in isolation from other applications), thereby preventing an anti-virus application from accessing/reading the executable files of these applications in order to scan the files for the presence of malware. Similarly, Apple's iOS operating system restricts each application to a unique location in the file system that is referred to as the application's sandbox. Each application has access to the contents of its own sandbox but cannot access other applications' sandboxes.

### SUMMARY

It is an object of the present invention to overcome or at least mitigate the problem of scanning a computer device to detect malware when the operating system running on the computer device prevents applications installed on the device from accessing/reading the files of other applications installed on the device.

According to a first aspect of the present invention there is provided a method of scanning a computer device in order to detect potential malware when an operating system running on the computer device prevents applications installed on the device from accessing installed files of other applications installed on the device. The method comprising the steps of:
detecting installation of an application on the device;
identifying one or more installation files that are required to perform the installation of the application; and
performing a malware scan of the identified installation files and/or information obtained from the installation files.

The step of performing a malware scan of the identified installation files and/or information obtained from these installation files can be implemented at installation of the application and/or after the installation of the application has been completed.

The information obtained from the installation files may comprise one or more of:
a hash of the installation files;
a hash of any files contained within the installation files; and
a hash of a signer certificate
data relating to the components of the application.

The step of detecting installation of an application on the device may comprise receiving a notification that an application is to be installed or has been installed on the device and/or intercepting a function call, message or event indicating that an application is to be installed or has been installed on the device.

The step of performing a malware scan of the identified installation files and/or information obtained from these installation files may comprises comparing the installation files and/or information obtained from these installation files with malware identification information. The malware identification information can be provided by a malware identification database.

The step of comparing the installation files and/or information obtained from these installation files with malware identification information may further comprise comparing the installation files with signatures that identify potential malware and/or comparing the installation files with heuristic rules that identify potential malware.

When it is desired to perform a malware scan of the device after the installation of the application has been completed, the method may further comprise performing a malware scan of the installation files that were used to perform the installation of the application. To do so, the applications installed on the device can be identified. A malware scan of installation files stored on the device that were used to perform installation of each installed application would then be performed.

The method may further comprise, at installation of the application, storing the information obtained from the installation files, and, when it is desired to perform a malware scan of the device after the installation of the application has been completed, performing a malware scan of the stored information obtained from the installation files.

According to a second aspect of the present invention there is provided a computer program, comprising computer readable code which, when run on a computer device, causes the computer device to perform the method according to the first aspect of the present invention.

According to a third aspect of the present invention there is provided a computer program product comprising a computer readable medium and a computer program according to the second aspect of the present invention, wherein the computer program is stored on the computer readable medium.

According to a fourth aspect of the present invention there is provided a computer device comprising a processor for detecting installation of an application on the device, identifying one or more installation files that are required to perform the installation of the application, and for performing a malware scan of the identified installation files and/or information obtained from the installation files.

The processor may be configured to perform a malware scan of the identified installation files and/or information obtained from these installation files at installation of the application, and/or after the installation of the application has been completed.

The processor may be configured to the obtain information from the installation files that comprises one or more of:
a hash of the installation files;
a hash of any files contained within the installation files; and
a hash of a signer certificate
data relating to the components of the application.

To detect installation of an application on the device, the processor may configured to receive a notification that an application is to be installed or has been installed on the device, and/or to intercept a function call, message or event indicating that an application is to be installed or has been installed on the device.

The processor may be configured to perform a malware scan of the identified installation files and/or information obtained from these installation files that comprises comparing the installation files and/or information obtained from these installation files with malware identification information. The computer device may be configured to obtain the malware identification information from a malware identification database. To compare the installation files and/or information obtained from these installation files with malware identification information, the processor may be configured to compare the installation files with signatures that identify potential malware, and/or compare the installation files with heuristic rules that identify potential malware.

The processor may be configured such that, when it is desired to perform a malware scan of the device after the installation of the application has been completed, a malware scan of the installation files that were used to perform the installation of the application is performed. The processor may be configured to identify applications installed on the device and perform a malware scan of installation files stored on the device that were used to perform installation of each installed application.

The processor may be configured to ensure that the information obtained from the installation files at installation of the application is stored, and, when it is desired to perform a malware scan of the device after the installation of the application has been completed, to perform a malware scan of the stored information obtained from the installation files.

According to a fifth aspect of the present invention there is provided a method of scanning a computer device in order to detect potential malware when an operating system running on the computer device prevents applications installed on the device from accessing installed files of other applications installed on the device. The method comprises:
detecting installation of an application on the device;
identifying one or more installation files that are required to perform the installation of the application;
obtaining information from the identified installation files and storing the information; and
when it is desired to perform a malware scan of the device after the installation of the application has been completed, performing a malware scan of the stored information obtained from the installation files.

According to a sixth aspect of the present invention there is provided a computer program, comprising computer readable code which, when run on a computer device, causes the computer device to perform the method according to the fifth aspect of the present invention.

According to a seventh aspect of the present invention there is provided a computer program product comprising a computer readable medium and a computer program according to the sixth aspect of the present invention, wherein the computer program is stored on the computer readable medium.

According to an eighth aspect of the present invention there is provided a computer device. The computer device comprises a processor for detecting installation of an application on the device, identifying one or more installation files that are required to perform the installation of the application, obtaining information from the identified installation files and ensuring that the information is stored, and, when it is desired to perform a malware scan of the device after the installation of the application has been completed, performing a malware scan of the stored information obtained from the installation files.

### BRIEF DESCRIPTION OF THE DRAWINGS

FIG. 1 illustrates schematically a computer device suitable for implementing the methods described herein;

FIG. 2 is a flow diagram illustrating an example of the process of performing a malware scan according to the methods described herein;

FIG. 3 is a flow diagram illustrating an example of the process of performing a malware scan according to the methods described herein; and

FIG. 4 is a flow diagram illustrating an example of the process of performing a malware scan according to the methods described herein.

### DETAILED DESCRIPTION

It has been recognised here that, whilst those operating systems that allow a device to rapidly access functionality by downloading and installing “apps” are often designed with a strict security architecture that prevents software applications from reading the files of another application, thereby also preventing anti-virus applications from performing malware scanning of installed applications, these operating systems are typically configured such that an application that is to be installed onto a device running the operating system must be provided as one or more installation files of a specific format. The operating system then uses these installation files to install the files that form the application onto the device. For example, Google's Android™ operating system requires that applications are distributed and installed in Android Package (APK) file format. Similarly, Apple's iOS operating system requires that applications are distributed and installed in iPhone/iPod Touch Application (IPA) file format.

It is therefore proposed herein to provide a method of scanning for potential malware in which, if an operating system running on a computer device prevents applications installed on the device from accessing/reading the files of other applications installed on the device, then an anti-virus application provided on the computer device will attempt to detect malware present within an application by scanning the installation files that are used to perform the installation of the application and/or information obtained from these installation files. This method therefore provides that applications that are installed on the device, or that are scheduled to be installed on the device, can be scanned for the presence of malware, even if the operating system is configured in such a way that prevents an anti-virus application from reading the installed files of an application.

It has also been recognised here that there are a various ways in which an anti-virus application can implement the scanning of the installation files of an application. Firstly, the anti-virus application can detect the installation of an application, and thereby identify the installation files that are to be used, are being used or have been used for the installation. The installation can be detected prior to, during, or just after installation of the application has been completed. The anti-virus application can then scan the installation files. In addition, or as an alternative, the anti-virus application can obtain information from these installation files (e.g. metadata relating to the installation files) and perform a malware scan of the obtained information. The anti-virus application can also store any information obtained from the installation files for use in any subsequent malware scanning procedures.

It is also proposed herein that, in addition or as an alternative to the scanning of installation files at installation of an application, an anti-virus application can perform on-demand and/or scheduled scanning of installation files, and/or information obtained from these installation files, at any time after installation of an application. For example, when a malware scan is requested by a user, or a scheduled scan is due, the anti-virus application identifies all of the applications installed on the device, identifies the installation files of each of the identified applications, provided that they are still present on the device, and scans the identified installations files. In addition or as an alternative to scanning installations files, the anti-virus application can store the information obtained from installation files at installation of any applications, and the anti-virus application can then scan this stored information at any time after installation of the application. This is particularly useful if the installation files for an application have been deleted after installation of the application, or if the installation files have been altered after installation as a means of implementing copy protection. Furthermore, the scanning of information obtained from the installation files is likely to be significantly quicker than the scanning of the installation files themselves.

By way of example only, the method will now be further described with reference to a device running the Android™ operating system. In order to install an application, a device running the Android™ operating system receives an installation file provided in Android Package (APK) file format. An APK file is composed of one or more files that form the application compiled into a single archive file. This archive file includes the Android applications code files, resource files, assets, certificates, and a manifest file. The Android™ operating system can then install the application using this installation file. However, given that the Android™ operating system restricts each application to its own sandbox, the installed application files are inaccessible to other applications, including any anti-virus applications present on the device. Therefore, in accordance with the method described above, an anti-virus application will detect the installation of an application on the device, and will scan the APK installation file that is used to perform the installation of the application and/or information obtained from this APK file.

In order to detect the installation of an application, the anti-virus application registers to receive a relevant broadcast notification from the Android™ operating system. For example, the anti-virus application can register to receive an “android.intent.action.PACKAGE_ADDED” broadcast notification that indicates that a new application package has been installed on the device, or an “android.intent.action.PACKAGE_INSTALL” broadcast notification that triggers the download and eventual installation of a package. The anti-virus application can either statically register to receive a broadcast notification (e.g. using a <receiver> tag in the AndroidManifest.xml file of the anti-virus application) or dynamically register to receive a broadcast notification (e.g. using the Context.registerReceiver( ) object). From this notification, the anti-virus application identifies the APK installation file for the application and performs a malware scan of the APK file. This malware scan will typically be performed using a local and/or remote database of malware data, such as malware signatures and/or heuristic analysis rules, that is used to identify potential malware by examining any of the components of the APK file.

The anti-virus application can also implement retroactive scanning of each APK installation file associated with the applications currently installed on the device and/or information obtained from these APK files at any time after the installation of an application. In doing so, the anti-virus application can ensure that an application that may potentially be malware can be identified even if the signature or heuristic rules for identifying that malware are only made available at some point after installation of the application. This retroactive scanning of the APK installation files and/or information obtained from the APK installation files can be performed on-demand and/or in accordance with a defined schedule. For example, a retroactive malware scan could be initiated following an update to a malware identification database that provides malware identification information.

In order to perform this retroactive scanning of the APK installation files and/or information obtained from the APK installation files, the anti-virus application can identify all of the applications that are currently installed on the device. For example, the anti-virus application can use the PackageManager.getInstalledPackages( ) object to obtain a list of all packages that are installed on the device from the Android™ operating system. The anti-virus application can then perform a malware scan of the APK files from which each of these applications were installed. However, if APK files associated with any of these applications were deleted after the installation of the corresponding application, or if the original APK files associated with any of these applications were modified after installation, then there is a risk that simply scanning these APK files will not reliably identify any potential malware.

To mitigate this risk, the anti-virus application can inspect the APK file at installation of an application, and extract information regarding the attributes/components of the APK file. The information obtained from the APK file can then be stored in an installed applications database. The installed applications database contains the identities of all applications currently stored on the device together with the information obtained from the application's APK installation file. For example, the information obtained from an APK installation file and stored in the applications database can include:
a hash of the original installation files (e.g. the value calculated by the application of the SHA-1 cryptographic hash function over the full APK file);
a hash of any of the files that are nested inside the installation files (e.g. a hash of any of the files archived with an APK file); and/or
information/data extracted from any of the files that are nested inside the installation files (e.g. such as permissions, requested activity, signer certificate, services and the name of application from within an AndroidManifest.xml file, names of Java classes and methods extracted from .dex/.class files, and/or CcII sequences inside of class files).

The information stored in the installed applications database can then be scanned for malware at any time after the installation of an application. This is also particularly useful if the original APK file is deleted after the application has been installed, or if the original APK file is modified after installation as a means of implementing copy protection (e.g. forward lock). In addition, this scanning of information stored in the installed applications database provides improved performance, as it is not necessary to access the original installation files. In particular, the scanning of information stored in the installed applications database can be performed in parallel (e.g. using a multi query procedure or several scanning threads).

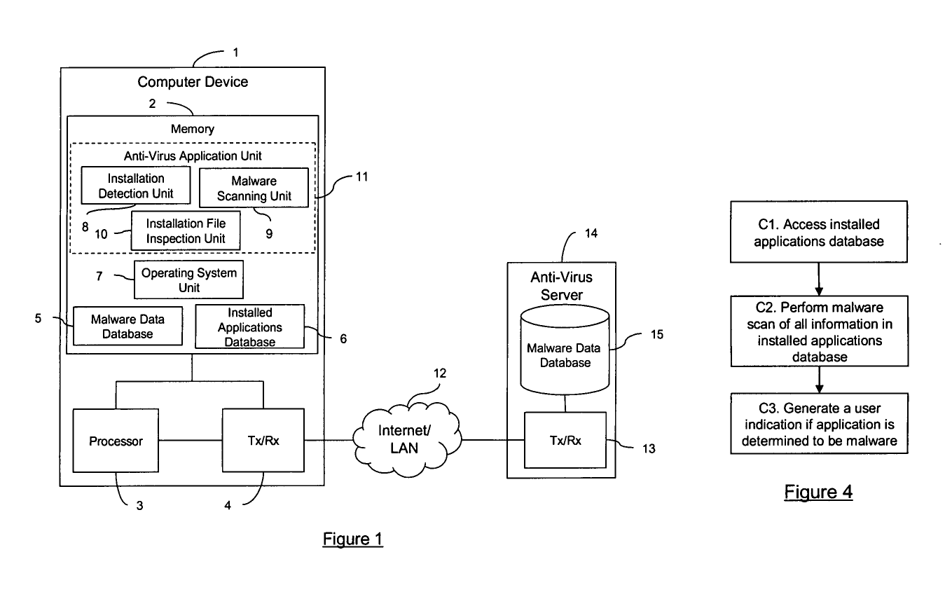

FIG. 1 illustrates schematically an example of a computer device 1 suitable for implementing the methods described herein. The computer device 1 can be implemented as a combination of computer hardware and software. The computer device 1 comprises a memory 2, a processor 3 and a transceiver 4. The memory 2 stores the various programs/executable files that are implemented by the processor 3, and also provides a computer system memory that stores any data required by the computer device 1. This data can include a local malware data database 5 that can be used when performing a malware scan in order to identify potential malware, and an installed applications database 6 that is used to store any information obtained from installation files at installation of any applications. The programs/executable files stored in the memory 2, and implemented by the processor 3, can include an operating system unit 7, an installation detection unit 8, a malware scanning unit 9 and an installation file inspection unit 10. The installation detection unit 8, malware scanning unit 9 and installation file inspection unit 10 can be sub-units of an anti-virus application unit 11. The transceiver 4 is used to communicate over a network 12 such as a LAN or the Internet with a transceiver 13 of an anti-virus server 14, anti-virus server 14 providing a remote malware data database 15 that can be used when performing a malware scan in order to identify potential malware. Typically, the computer device may be any of a desktop personal computer (PC), laptop, tablet, personal data assistant (PDA), mobile phone, smart phone, or any other such device

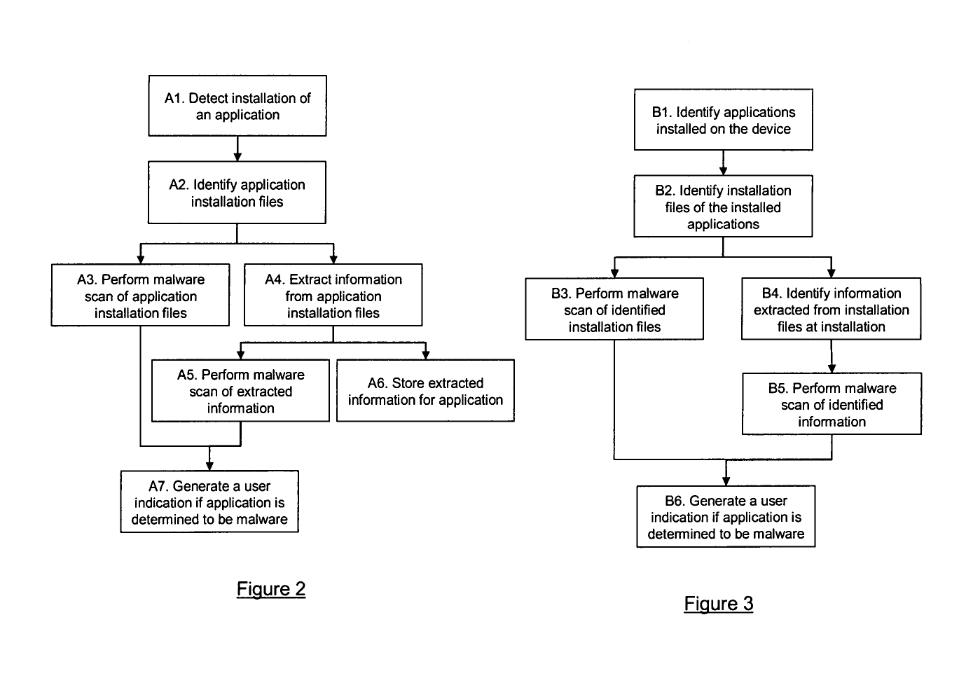

FIG. 2 is a flow diagram illustrating an example of the process of performing a malware scan of a device when the device is running an operating that prevents applications installed on the device from accessing/reading the installed files of other applications installed on the device. The steps are performed as follows:
A1. An anti-virus application detects the installation of an application on the device. For example, the anti-virus application can receive a notification from the operating system indicating that an application is to be installed or has been installed. Alternatively, the anti-virus application could hook/intercept any function calls, messages or events passed between software components that relate to the installation of an application.
A2. The anti-virus application then identifies the installation file(s) that are to be used, are being used or have been used to perform the installation of the application.
A3. The anti-virus application then uses a local and/or remote database of malware data, such as malware signatures and/or heuristic analysis rules, to scan the identified installation file(s) to determine if the application is potentially malware.
A4. In addition or as an alternative, the anti-virus application can also extract information from the installation file(s). For example, the information obtained from the installation file(s) can include a hash of the installation file(s), a hash of any of files that are nested inside the installation file(s), information/data extracted from any of the files that are nested inside the installation file(s) etc.
A5. The anti-virus application then uses a local and/or remote database of malware data, such as malware signatures and/or heuristic analysis rules, to scan the extracted information to determine if the application is potentially malware.
A6. The information obtained from the installation file(s) can then be stored in an installed applications database. The installed applications database contains the identities of all applications currently stored on the device together with the information obtained from the installation file(s) of these applications, and can be used in any subsequent malware scanning procedures.
A7. If the anti-virus application determines that the application is potentially infected with malware during the scanning steps of A3 and/or A5, then the anti-virus application generates an indication to the user of the device. The user can then decide what actions should be taken with regards to this application.

In addition, the anti-virus application can also detect if any applications are removed/uninstalled from the device and remove any associated information from the installed applications database to ensure that the installed applications database is accurate.

FIG. 3 is a flow diagram illustrating an example of the process of performing a retroactive malware scan of the applications installed on a device when the device is running an operating that prevents applications installed on the device from accessing/reading the files of other applications installed on the device. The steps are performed as follows:
B1. The anti-virus application identifies all applications currently installed on the device.
B2. The anti-virus application then identifies installation files associated with each of the identified applications, provided that these installation files are still stored on the device.
B3. The anti-virus application then uses a local and/or remote database of malware data, such as malware signatures and/or heuristic analysis rules, to scan the identified installation files to determine if any of the installed applications are potentially malware.
B4. In addition or as an alternative, the anti-virus application can also access the installed applications database, which stores information obtained from installation files at installation of each application, and identifies any information that is stored in the installed applications database for each of the identified applications.
B5. The anti-virus application then uses a local and/or remote database of malware data, such as malware signatures and/or heuristic analysis rules, to scan the identified information to determine if any of the installed applications are potentially malware.
B6. If the anti-virus application determines that any of the installed applications are potentially infected with malware during the scanning steps of B3 and/or B5, then the anti-virus application generates an indication to the user of the device. The user can then decide what actions should be taken with regards to these applications.

FIG. 4 is a flow diagram illustrating an alternative example of the process of performing a retroactive malware scan of the applications installed on a device when the device is running an operating that prevents applications installed on the device from accessing/reading the files of other applications installed on the device. The steps are performed as follows:
C1. The anti-virus application accesses the installed applications database. The installed applications database contains the identities of all applications currently stored on the device together with the information obtained from the installation file(s) of these applications.
C2. The anti-virus application then uses a local and/or remote database of malware data, such as malware signatures and/or heuristic analysis rules, to scan all of the information stored in the installed applications database to determine if any of the installed applications are potentially malware.
C3. If the anti-virus application identifies any applications as potentially infected with malware during the scanning step of C2, then the anti-virus application generates an indication to the user of the device. The user can then decide what actions should be taken with regards to these applications.

It will be appreciated by the person of skill in the art that various modifications may be made to the above described embodiments without departing from the scope of the present invention. For example, whilst some of the embodiments have been described with reference to a device running the Android™ operating system and application installation files that use the associated APK file format, the methods described above are not limited to the Android™ operating system but are equally applicable to any operating system.

1. A method of scanning a computer device in order to detect potential malware when an operating system running on the computer device prevents applications installed on the device from accessing installed files of other applications installed on the device, the method comprising the steps of:
detecting installation of an application on the device;
identifying one or more installation files that are required to perform the installation of the application; and
performing a malware scan of the identified installation files and/or information obtained from the installation files.

2. A method as claimed in claim 1, wherein the step of performing a malware scan of the identified installation files and/or information obtained from these installation files is implemented at one or more of:
installation of the application; and
after the installation of the application has been completed.

3. A method as claimed in claim 1, wherein the information obtained from the installation files comprise one or more of:
a hash of the installation files;
a hash of any files contained within the installation files; and
a hash of a signer certificate
data relating to the components of the application.

4. A method as claimed in claim 1, wherein the step of detecting installation of an application on the device comprises one or more of:
receiving a notification that an application is to be installed or has been installed on the device; and
intercepting a function call, message or event indicating that an application is to be installed or has been installed on the device.

5. A method as claimed in claim 1, wherein the step of performing a malware scan of the identified installation files and/or information obtained from these installation files comprises:
comparing the installation files and/or information obtained from these installation files with malware identification information.

6. A method as claimed in claim 5, wherein the malware identification information is provided by a malware identification database.

7. A method as claimed in claim 5, wherein the step of comparing the installation files and/or information obtained from these installation files with malware identification information further comprises one or more of:
comparing the installation files with signatures that identify potential malware; and
comparing the installation files with heuristic rules that identify potential malware.

8. A method as claimed in claim 2, and further comprising:
when it is desired to perform a malware scan of the device after the installation of the application has been completed, performing a malware scan of the installation files that were used to perform the installation of the application.

9. A method as claimed in claim 8, and further comprising:
identifying applications installed on the device, and performing a malware scan of installation files stored on the device that were used to perform installation of each installed application.

10. A method as claimed in claim 1, and further comprising:
at installation of the application, storing the information obtained from the installation files; and
when it is desired to perform a malware scan of the device after the installation of the application has been completed, performing a malware scan of the stored information obtained from the installation files.

11. A computer program, comprising computer readable code which, when run on a computer device, causes the computer device to perform the method as claimed in claim 1.

12. A computer program product comprising a computer readable medium and a computer program as claimed in claim 11, wherein the computer program is stored on the computer readable medium.

13. A computer device comprising:
a processor for detecting installation of an application on the device, identifying one or more installation files that are required to perform the installation of the application, and for performing a malware scan of the identified installation files and/or information obtained from the installation files.

14. A computer device as claimed in claim 13, wherein the processor is configured to perform a malware scan of the identified installation files and/or information obtained from these installation files at one or more of:
installation of the application; and
after the installation of the application has been completed.

15. A computer device as claimed in claim 13, wherein the processor is configured to the obtain information from the installation files that comprises one or more of:
a hash of the installation files;
a hash of any files contained within the installation files; and
a hash of a signer certificate
data relating to the components of the application.

16. A computer device as claimed in claim 13, wherein, to detect installation of an application on the device, the processor is configured to perform one or more of:
receiving a notification that an application is to be installed or has been installed on the device; and
intercepting a function call, message or event indicating that an application is to be installed or has been installed on the device.

17. A computer device as claimed in claim 13, wherein the processor is configured to perform a malware scan of the identified installation files and/or information obtained from these installation files that comprises:
comparing the installation files and/or information obtained from these installation files with malware identification information.

18. A computer device as claimed in claim 17, wherein the computer device is configured to obtain the malware identification information from a malware identification database.

19. A computer device as claimed in claim 17, wherein, to compare the installation files and/or information obtained from these installation files with malware identification information, the processor is configured to perform one or more of:
comparing the installation files with signatures that identify potential malware; and
comparing the installation files with heuristic rules that identify potential malware.

20. A computer device as claimed in claim 13, wherein, when it is desired to perform a malware scan of the device after the installation of the application has been completed, the processor is configured to perform a malware scan of the installation files that were used to perform the installation of the application.

21. A computer device as claimed in claim 20, wherein the processor is configured to identify applications installed on the device and perform a malware scan of installation files stored on the device that were used to perform installation of each installed application.

22. A computer device as claimed in claim 13, wherein the processor is configured to store the information obtained from the installation files at installation of the application, and, when it is desired to perform a malware scan of the device after the installation of the application has been completed, to perform a malware scan of the stored information obtained from the installation files.

23. A method of scanning a computer device in order to detect potential malware when an operating system running on the computer device prevents applications installed on the device from accessing installed files of other applications installed on the device, the method comprising:
detecting installation of an application on the device;
identifying one or more installation files that are required to perform the installation of the application;
obtaining information from the identified installation files and storing the information; and
when it is desired to perform a malware scan of the device after the installation of the application has been completed, performing a malware scan of the stored information obtained from the installation files.

24. A computer program, comprising computer readable code which, when run on a computer device, causes the computer device to perform the method as claimed in claim 23.

25. A computer program product comprising a computer readable medium and a computer program as claimed in claim 24, wherein the computer program is stored on the computer readable medium.

26. A computer device comprising:
a processor for detecting installation of an application on the device, identifying one or more installation files that are required to perform the installation of the application, obtaining information from the identified installation files and ensuring that the information is stored, and, when it is desired to perform a malware scan of the device after the installation of the application has been completed, performing a malware scan of the stored information obtained from the installation files.
